(19) United States
(12) Patent Application Publication
(10) Pub. No.: US 2015/0252763 A1
(43) Pub. Date: Sep. 10, 2015

(54) FUEL PUMP

(71) Applicant: KAWASAKI JUKOGYO KABUSHIKI KAISHA, Hyogo (JP)

(72) Inventors: Tetsuya Mori, Kobe-shi (JP); Yasuhisa Okabe, Akashi-shi (JP)

(21) Appl. No.: 14/424,243

(22) PCT Filed: Jul. 5, 2013
(86) PCT No.: PCT/JP2013/068491

§ 371 Date: Feb. 26, 2015

(30) Foreign Application Priority Data
Sep. 4, 2012 (JP) 2012-194274

(51) Int. Cl. F02M 59/04; F04B 17/05; F04B 1/20; F02M 59/10

(52) U.S. Cl. CPC F02M 59/04; F02M 59/102; F04B 17/05; F04B 1/2078

(57) ABSTRACT

A fuel pump outside a fuel tank, having an enhanced-durability bearing. The fuel pump includes: a drive shaft; a rotary swash plate fixed to the drive shaft; a cylinder; and a piston biased such that one end thereof abuts against the rotary swash plate and movable inside of the cylinder according to the rotation of the rotary swash plate. The rotary swash plate includes an annular rotary plate that abuts against the piston and a bearing having a drive side first race fixed to the drive shaft, a driven side second race fixed to the annular rotary plate, and a plurality of rolling elements between the first race and the second race. The bearing has an inclination axis inclined with respect to the axis of the drive shaft. A straight line connecting contact points and between the rolling element and the races and is not perpendicular to the inclination axis.

### TECHNICAL FIELD

The present invention relates to a fuel pump for supplying fuel from a fuel tank to an engine and, more particularly, to a fuel pump disposed outside of a fuel tank.

### BACKGROUND ART

A fuel pump of an in-tank type that is disposed inside of a fuel tank is mainly used in an automobile and medium and large motorcycle. In contrast, a fuel pump that can be mounted outside of a fuel tank may be used in a small motorcycle for the purpose of the capacity secureness, miniaturization, and light weight of a fuel tank.

A rotary swash plate type axial piston pump (hereinafter referred to as “a rotary swash plate type fuel pump”) has been known as a fuel pump that can be mounted outside of a fuel tank, as disclosed in Patent Document 1. The rotary swash plate type fuel pump includes a drive shaft, a rotary swash plate, a cylinder, a piston configured to be movable inside of the cylinder, and a drive device. The drive device rotates the drive shaft so as to rotate the rotary swash plate fixed to the drive shaft with an inclination with respect to the drive shaft. The axis of the piston is parallel to the axis of the drive shaft. The piston is biased toward the rotary swash plate. As a consequence, the rotation of the rotary swash plate is converted into the reciprocating motion of the piston. The rotary swash plate type fuel pump sucks fuel into the cylinder owing to the reciprocating motion of the piston, pressurizes the fuel by the piston, and thus, supplies the fuel to an engine under a predetermined pressure.

Moreover, providing a bearing between the rotary swash plate and the drive shaft has been known in the rotary swash plate type fuel pump. In this manner, the rotary swash plate can be smoothly rotated with respect to the drive shaft, thereby reducing a coefficient of kinetic friction between the rotary swash plate and the piston, so as to suppress galling or abrasion between the rotary swash plate and the piston.

### PRIOR ART DOCUMENT

### Patent Document

Patent Document 1: Japanese Patent Laid-open Publication No. JP 2008-255846

### SUMMARY OF THE INVENTION

### Problems to be Solved by the Invention

A fuel tank is generally disposed in the vicinity of an engine and an exhaust pipe in a motorcycle. Therefore, in the case where a fuel pump is disposed outside of the fuel tank, the fuel pump is disposed in the vicinity of the engine and the exhaust pipe. Consequently, the fuel pump is exposed to heat generated at the engine and the exhaust pipe, and therefore, the temperature of the fuel staying inside of the fuel pump is increased. As a result, vapor of the fuel (bubbles of the evaporated fuel) may be generated inside of the fuel pump.

The rotary swash plate type fuel pump further includes a high pressure fuel chamber communicating with a fuel discharge port and a fuel sump chamber communicating with a fuel suction port. When the fuel is sucked from the fuel sump chamber to a cylinder by the reciprocating motion of the piston, pressure inside of the fuel sump chamber is decreased. As a consequence, in addition to the above-described increase in fuel temperature, a decrease in vapor pressure of the fuel caused by the decrease in pressure inside of the fuel sump chamber further promotes the generation of the vapor inside of the fuel sump chamber.

Moreover, the bearing interposed between the rotary swash plate and the drive shaft inside of the rotary swash plate type fuel pump is disposed at the fuel sump chamber. The fuel sump chamber communicates with the fuel tank, and therefore, is filled with the fuel flowing from the fuel tank. Consequently, the entire bearing is normally soaked in the fuel that functions as a lubricant with respect to the bearing. However, in the case where a large quantity of vapor is generated inside of the rotary swash plate type fuel pump, as described above, the bearing may be partly covered with the vapor, and therefore, may not be soaked in the fuel. In this case, lubrication with respect to the bearing is insufficient or a rotational load is uneven, thus raising problems that the abrasion of the bearing promotes and the lifetime of the rotary swash plate type fuel pump shortens.

The present invention has been accomplished to solve the above-described problems. Specifically, an object of the present invention is to provide a rotary swash plate type fuel pump disposed outside of a fuel tank, in which the durability of a bearing interposed between a rotary swash plate and a drive shaft inside of the rotary swash plate type fuel pump can be enhanced.

### Solutions to the Problems

A fuel pump according to the present invention is provided outside of a fuel tank, for sucking fuel staying in the fuel tank and supplying the fuel to an engine, the fuel pump includes a drive shaft, a rotary swash plate fixed to the drive shaft, a cylinder and a piston provided in such a manner as to be biased such that one end thereof abuts against the rotary swash plate and be movable inside of the cylinder according to the rotation of the rotary swash plate, wherein the rotary swash plate includes an annular rotary plate that abuts against the piston and a bearing having a drive side first race fixed to the drive shaft, a driven side second race fixed to the annular rotary plate, and a plurality of rolling elements interposed between the first race and the second race, the bearing having an inclination axis inclined with respect to the axis of the drive shaft, and a straight line connecting contact points between the rolling element and the races not being perpendicular to the inclination axis.

With the above-described configuration, the straight line connecting the contact points between the rolling element of the bearing and the first and second races is not perpendicular to the inclination axis of the bearing, thereby improving the load resistance of the bearing with respect to the load in the piston operational direction which is exerted on the rotary swash plate. Consequently, even in the case where vapor is generated inside of the rotary swash plate type fuel pump so that the bearing inside of the rotary swash plate type fuel pump is insufficiently lubricated, the increase in load resistance of the bearing can secure the durability of the bearing. In particular, the durability of the bearing according to the present invention with respect to the load in the piston operational direction can be more enhanced than the case of a bearing (i.e., a radial bearing) in which a straight line connecting contact points between races of a bearing and a rolling element is perpendicular to an inclination axis.

It is preferable that the present invention should be further equipped with the following features.

(1) The bearing is a thrust bearing or an angular bearing.
(2) The first race has an inner-diameter portion on the inclination axis and an annular seat on the drive side perpendicular to the inner-diameter portion, and the drive shaft has a cylindrical inclination surface to be fitted to the inner-diameter portion and a thrust bearing surface abutting against the annular seat.
(3) In the above feature (2), the drive shaft is provided with a drive shaft body and a fixed shaft that is formed independently of the drive shaft body and is fixed to the drive shaft body, the fixed shaft is provided with the cylindrical inclination surface and the thrust bearing surface.
(4) The fuel pump is mounted on a motorcycle while placing the axis of the drive shaft in a substantially horizontal direction, the fuel pump further includes a fuel suction port communicating with the fuel tank and a fuel sump chamber communicating with the fuel suction port and the cylinder, wherein the rotary swash plate is disposed inside of the fuel sump chamber, and the inclination axis extends in a direction crossing a vertical direction.
(5) In the above feature (4), there are provided a plurality of cylinders, the number of cylinders disposed below the axis of the drive shaft is greater than that of cylinders disposed above the axis of the drive shaft.
(6) In the above feature (4) or (5), the fuel pump further includes a vapor relief channel that is formed independently of the fuel suction port and communicates from the fuel sump chamber to the fuel tank.

With the above-described feature (1), it is possible to increase the load resistance with respect to the load in the piston operational direction in comparison with the case where a radial bearing is adopted.

With the above-described feature (2), it is possible to secure the first race of the bearing in the state inclined with respect to the axis of the drive shaft by providing the cylindrical inclination surface on the inclination axis of the bearing at the drive shaft and fitting the inner-diameter portion of the first race of the bearing to the cylindrical inclination surface of the drive shaft. As a consequence, it is possible to readily form the rotary swash plate provided with the bearing having the inclination axis inclined with respect to the drive shaft.

With the above-described′feature (3), it is possible to readily fabricate the drive shaft since the drive shaft may separately include the cylindrical drive shaft body and the fixed shaft, to which the bearing is secured with the inclination.

The above-described feature (4) specifically relates to the rotary swash plate type fuel pump mounted outside of a fuel tank for a motorcycle. In the case where vapor is generated inside, of the rotary swash plate type fuel pump, the bearing interposed between the rotary swash plate and the drive shaft may be insufficiently lubricated in a motorcycle. However, with the bearing according to the present invention, it is possible to ensure the durability of the bearing.

With the above-described feature (5), it is possible to reduce the number of cylinders arranged above inside of the rotary swash plate type fuel pump, into which Vapor is liable to flow, so as to reduce the quantity of vapor flowing into the cylinder. As a consequence, it is possible to suppress a decrease in fuel discharge quantity to be supplied to an engine so as to prevent vapor lock.

With the above-described feature (6), it is possible to discharge the vapor generated inside of the rotary swash plate type fuel pump to the fuel tank, so as to secure the lubrication of the bearing with the fuel and suppress the inflow of the vapor into the cylinder.

### Effects of the Invention

In summary, according to the present invention, the load resistance of the bearing is improved so that it is possible to ensure the durability of the bearing even if the rotary swash plate type fuel pump is placed in a situation in which the vapor is liable to be generated so that the bearing inside of the fuel pump is insufficiently lubricated.

### BRIEF DESCRIPTION OF THE DRAWINGS

FIG. 1 is a left side view showing a motorcycle provided with a rotary swash plate type fuel pump according to the present invention.

FIG. 2 is a cross-sectional view showing the configuration of the rotary swash plate type fuel pump according to the present invention.

FIG. 3 is an enlarged cross-sectional view showing a rotary swash plate according to a first embodiment.

FIG. 4 is a cross-sectional view showing the arrangement of a cylinder inside of the rotary swash plate type fuel pump.

FIG. 5 is an enlarged cross-sectional view showing a rotary swash plate according to a second embodiment.

FIG. 6 is an enlarged cross-sectional view showing another embodiment of a bearing fixing portion at a drive shaft.

### EMBODIMENTS OF THE INVENTION

### First Embodiment

(Configuration of Motorcycle)

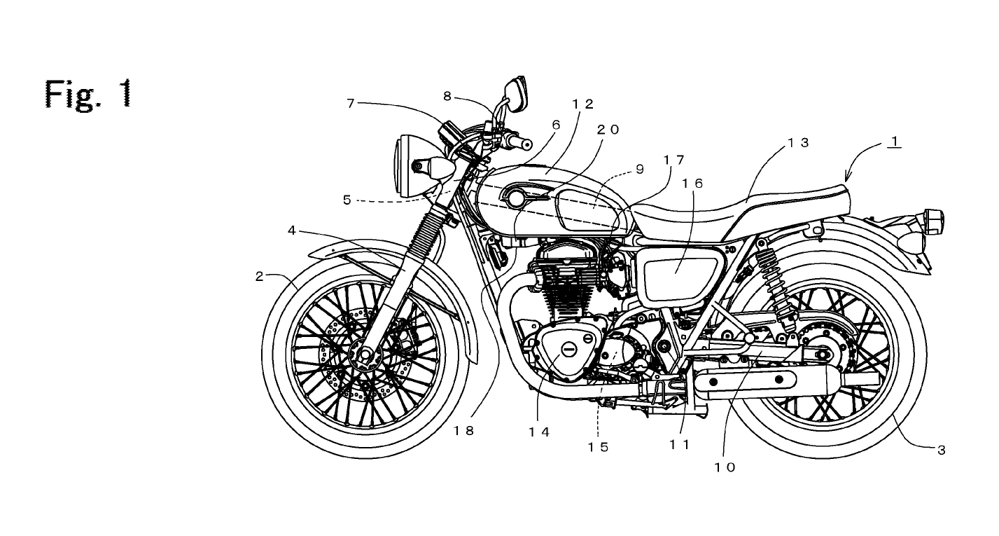

FIG. 1 is a left side view showing a motorcycle 1 provided with a rotary swash plate type fuel pump according to a first embodiment of the present invention. Here, explanation will be made based on the idea as directions used in the present embodiment coincide with the directions as viewed from a rider of the motorcycle 1.

As shown in FIG. 1, the motorcycle 1 is provided with a front wheel 2 and a rear wheel 3. The front wheel 2 is rotatably supported under a front fork 4 extending in a substantially vertical direction. The front fork 4 is supported by a steering shaft 5. The steering shaft 5 is rotatably supported by a head pipe 6. A steering handle 8 of a bar type extending laterally is fixed to an upper bracket 7 disposed at the upper end of the front fork 4. Consequently, when a rider laterally swings the steering handle 8, the front wheel 2 is steered on the steering shaft 5 as a rotary shaft.

A chassis frame 9 extends backward of the head pipe 6. The front end of a swing arm 10 is pivoted to the lower rear end portion of the chassis frame 9 via a pivot bolt 11. The rear wheel 3 is rotatably supported at the rear end of the swing arm 10. Above the chassis frame 9 and rearward of the steering handle 7 is disposed a fuel tank 12. Behind of the fuel tank 12 is disposed a seat 13 for a rider. An engine 14 is mounted at the lower portion of the fuel tank 12. An output sprocket 15 is disposed behind of the engine 14. Power is transmitted from the output sprocket 15 to the rear wheel 3.

An air cleaner 16 for purifying intake air to the engine 14 is disposed under the seat 13 and behind of the engine 14. The air cleaner 16 purifies air introduced from the front portion of the vehicle with a cleaner element, not shown, disposed inside of the air cleaner 16, and then, the cleaned air is designed to be fed to the engine 14.

A rotary swash plate type fuel pump 20 is fixed directly to the outer surface of the fuel tank 12 under the front portion of the fuel tank 12. The rotary swash plate type fuel pump 20 applies a predetermined pressure to the fuel taken from the fuel tank 12, and then, supplies the fuel to the engine 14 via a high pressure pipeline 17.

(Structure of Rotary Swash Plate Type Fuel Pump)

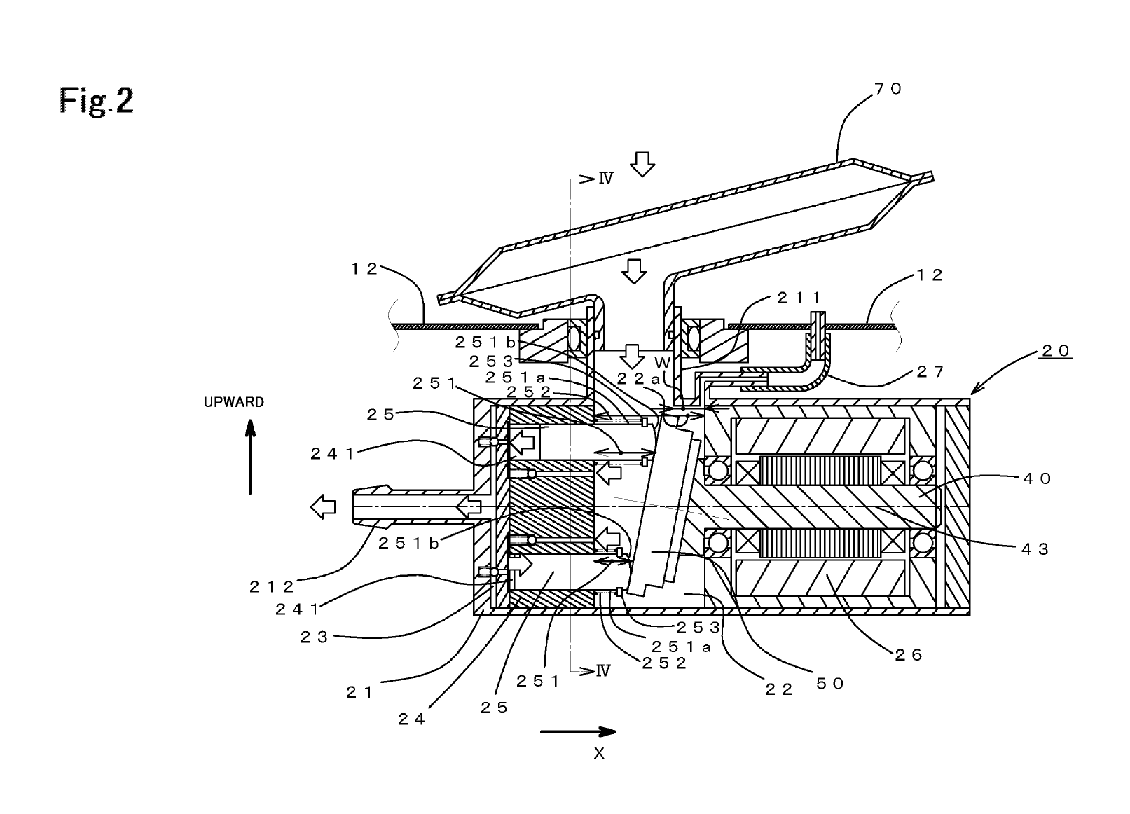

FIG. 2 is a vertically cross-sectional view showing the configuration of the rotary swash plate type fuel pump 20 according to the present embodiment. The fuel pump 20 is disposed directly at the lower surface of the fuel tank 12 and outside of the fuel tank 12 with a fuel suction port 211 formed upward while putting the axis 43 of a drive shaft 40 in a substantially horizontal direction. As shown in FIG. 2, the fuel pump 20 is provided with a housing 21 defining the external shape, a cylinder block 24, a piston 25, a drive device 26, the drive shaft 40, and a rotary swash plate 50. The housing 21 has the fuel suction port 211 connected to the fuel tank 12 and a fuel discharge port 212, through which the fuel is supplied to the engine 14. Moreover, inside of the housing 21 are formed a fuel sump chamber 22 communicating with the fuel suction port 211 and a high-pressure fuel chamber 23 communicating with the fuel discharge port 212. The cylinder block 24 is supported inside of the housing 21. The cylinder block 24 includes a plurality of cylinders 241 parallel to the axis 43 of the drive shaft 40 on the circumference on the axis 43 of the drive shaft 40. The cylinder 241 communicates with the fuel sump chamber 22 and the high-pressure fuel chamber 23. The drive shaft 40 is rotatably supported inside of the housing 21, and then, is rotatably driven by the drive device 26. The rotary swash plate 50 is fixed to the drive shaft 40 with an inclination with respect to the drive shaft 40. The piston 25 is movably disposed in a direction parallel to the axis 43 of the drive shaft 40 inside of the cylinder 241.

One end 251 of the piston 25 projects from the cylinder 241 toward the rotary swash plate 50. A spring stopper 253 is disposed at an outer peripheral surface 251a in the circumferential direction of the end 251. A compression spring 252 is interposed between the spring stopper 253 and the cylinder block 24 such that the piston 25 is biased in a direction (i.e., an X direction) in which the piston 25 is drawn from the cylinder 241 all the time. An abutment surface 251b against the rotary swash plate 50 at the end 251 of the piston 25 is finished into a smooth semispherical shape so as to slidably abut against the rotary swash plate 50 that is supported by the drive shaft 40 connected to the drive device 26 while being rotated together.

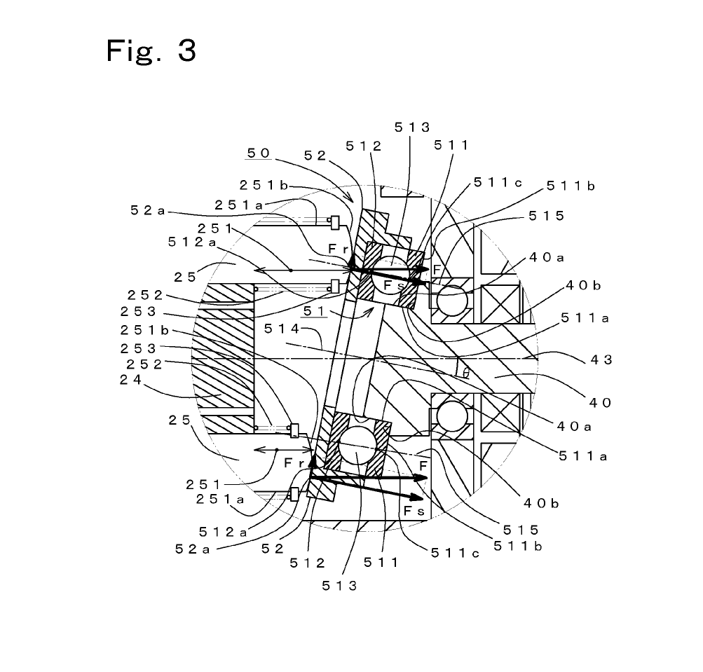

FIG. 3 is an enlarged view of FIG. 2, showing the rotary swash plate 50. As shown in FIG. 3, the rotary swash plate 50 has an annular rotary plate 52 that slidably abuts against the piston 25 and a bearing 51. The bearing 51 is provided with a drive side first race 511 that is disposed remotely from the piston 25 and fixed to the drive shaft 40, a driven side second race 512 that is disposed near the piston 25 and fixed to the annular rotary plate 52, and a rolling element 513 interposed between the first race 511 and the second race 512. The annular rotary plate 52 has an abutment surface inclined with respect to the axis 43 of the drive shaft 40. The bearing 51 has an inclination axis 514 inclined with respect to the axis 43 of the drive shaft 40. A straight line 515 connecting a contact point 511c between the first race 511 and the rolling element 513 and a contact point 512a between the second race 512 and the rolling element 513 has a component extending not perpendicularly to the inclination axis 514 but along the inclination axis 514. In this manner, the bearing 51 can receive a load in a thrust direction. A thrust bearing is used as the bearing 51 in the present embodiment.

Next, explanation will be made on a method for fixing the bearing 51 to the drive shaft 40 and the annular rotary plate 52. As shown in FIG. 3, the first race 511 of the bearing 51 has an inner-diameter portion She on the inclination axis 514 and an annular seat 511b on the drive side perpendicular to the inner-diameter portion 511a. The drive shaft 40 has a cylindrical inclination surface 40a on the inclination axis 514 and a thrust bearing surface 40b perpendicular to the cylindrical inclination surface 40a. When the inner-diameter portion 511a is fitted to the cylindrical inclination surface 40a of the drive shaft 40 whereas the annular seat 511b abuts against the thrust bearing surface 40b of the drive shaft 40, the first race 511 is fixed to the drive shaft 40. Consequently, the first race 511 is fixed integrally with the drive shaft 40 in a relatively unrotational manner.

The cylindrical inclination surface 40a and the thrust bearing surface 40b of the drive shaft 40 are formed into component parts integral with the drive shaft 40 by, for example, shaving.

The second race 512 is securely fitted to the annular rotary plate 52. The second race 512 is configured to be relatively rotatable with respect to the first race 511 via the rolling element 513. Specifically, the drive shaft for fixing the first race and the annular rotary plate 52, to which the second race is fitted, are configured to be rotatable on the inclination axis 514 relatively to each other. As a consequence, the abutment surface of the annular rotary plate 52 is configured to be rotatable on the inclination axis 43 relatively to the first race 511 by the bearing 51.

It is desirable that an angle θ formed between the inclination axis 514 and the axis 43 of the drive shaft 40 should be about 11 degrees. If the angle θ is too small, the reciprocating stroke of the piston 25 becomes insufficient, thereby inhibiting satisfactory fuel supply quantity and satisfactory pressure. In contrast, if the angle θ is too large, the piston 25 excessively pressurizes the fuel, thereby excessively increasing the pressure of the fuel or increasing a load on the drive device 26.

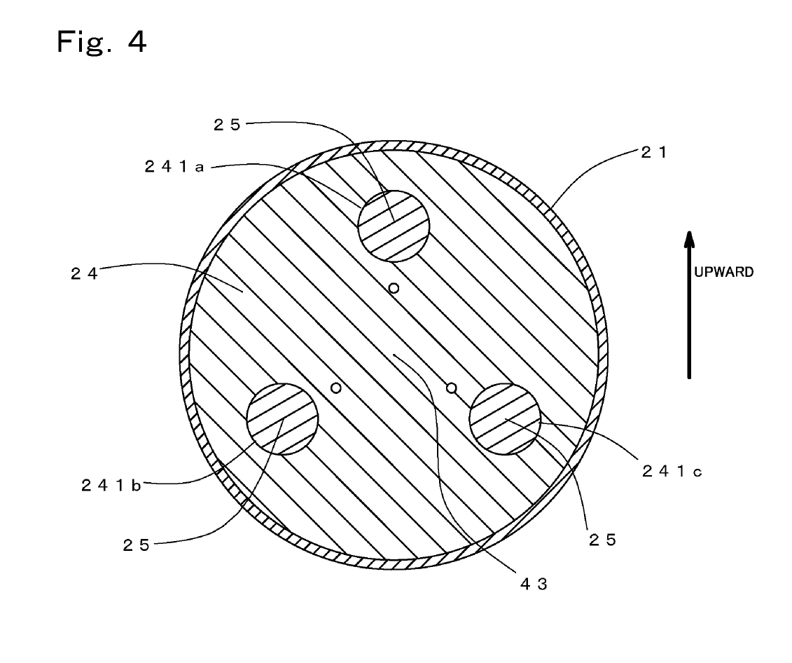

Furthermore, the fuel pump 20 according to the present invention takes countermeasures to prevent the vapor generated inside of the fuel pump 20 from being supplied to the engine 14. FIG. 4 is a cross-sectional view taken along a line IV-IV of FIG. 2. FIG. 4 shows the arrangement of the plurality of cylinders 241 inside of the fuel pump 20, in which the axis 43 of the drive shaft 40 extends in a substantially horizontal direction. In FIG. 4, three cylinders 241 are arranged. Among them, a cylinder 241a is arranged above the axis 43 of the drive shaft 40 whereas other cylinders 241b and 241c are arranged below the axis 43 of the drive shaft 40. Specifically, as for the plurality of cylinders 241 arranged, the number of cylinders 241a arranged above the axis 43 of the drive shaft 40 is smaller than that of cylinders 241b and 241c arranged below the axis 43 of the drive shaft 40. Here, the number of cylinders is not limited to three, and may be plural as long as the number of cylinders 241 arranged above the axis 43 of the drive shaft 40 is smaller than that of cylinders 241 arranged below the axis 43 of the drive shaft 40.

In addition, the fuel pump 20 according to the present invention takes countermeasures to discharge the vapor generated inside of the fuel pump 20 to the fuel tank 12. FIG. 2 shows a vapor relief channel 27 for allowing the fuel tank 12 and the fuel sump chamber 22 to communicate with each other apart from the fuel suction port 211. The vapor relief channel 27 is formed at a portion at which the vapor in the fuel sump chamber 22 is liable to stay. For example, as viewed from the top, the vapor cannot be readily discharged to the fuel tank so as to be likely to stay in a region W in which an upper opening 22a of the fuel sump chamber 22 is located outside of the fuel suction port 211 disposed above. Consequently, the region in which the vapor is liable to stay in the fuel sump chamber 22 communicates with the fuel tank 12. The vapor relief channel 27 may be an outside pipeline, and therefore, may be formed integrally with the housing 21 of the fuel pump 20.

Additionally, the fuel pump 20 according to the present invention takes countermeasures to suppress the generation of the vapor inside of the fuel pump 20. FIG. 1 shows a heat shielding plate 18 interposed between the fuel pump 20 and the engine. The heat shielding plate 18 shields heat radiating from the engine to the rotary swash type fuel pump, thus preventing an increase in temperature of the fuel staying inside of the fuel pump 20 and suppressing the generation of the vapor. Incidentally, in place of the addition of the heat shielding plate 18, an air introducing plate for introducing traveling air, a cooling fan, water-cooled means may be used as means for cooling the fuel pump 20.

As shown in FIG. 2, the fuel pump 20 further includes, at the fuel suction port 22, a fuel filter 70 for preventing foreign matter staying inside of the fuel tank 12 from flowing into the fuel pump 20. As a consequence, it is unnecessary to provide a pipeline for connecting the fuel pump 20 and the fuel filter 70 to each other, thereby readily laying a pipeline. Here, when the fuel filter 70 clogs, a pressure inside of the fuel pump 20 is decreased so that the vapor is liable to be generated. In view of this, the mesh size of the fuel filter 70 should be optimally selected.

Subsequently, referring to FIG. 2, a description will be given of the operation of the fuel pump 20 and the flow of the fuel. When the drive device 26 is driven, the drive shaft 40 is rotated. The rotation of the drive shaft 40 first rotates the first race 511 of the bearing 51 fitted to the drive shaft 40 at the same rotational speed as that of the drive shaft: Next, the rotation of the first race 511 is transmitted to the second race 512 on the driven side via the rolling element 514, thus rotating the second race 512. Hence, the annular rotary plate 52 fitted to the second race 512 is rotated. The annular rotary plate 52 is fixed to the axis 43 of the drive shaft 40 with the inclination. As a result, when the annular rotary plate 52 is rotated on the axis 43 of the drive shaft, the piston 25 biased toward the annular rotary plate 52 receives a reciprocating motion. In other words, the driving of the drive device 2 allows the piston 25 to make a reciprocating motion inside of the cylinder 241.

In FIG. 2, the flow of the fuel in the rotary swash plate type fuel pump is indicated by open arrows. The fuel flows from the fuel tank 12 into the fuel sump chamber 22 through the fuel suction port 211. The fuel sump chamber 22 is filled with the fuel. The reciprocating motion of the piston 25 allows the fuel to be sucked into the cylinder 241, followed by pressurizing, and thereafter, the fuel is discharged to the fuel high-pressure chamber 23. After that, the fuel is supplied to the engine 14 through the fuel discharge port 212 via the high-pressure pipeline 17.

The fuel pump 20 having the above-described configuration can produce the following effects.

Since friction is caused at an abutment portion 52a of the annular rotary plate 52 against the piston 25 by a load at the abutment portion 52a in a piston operational direction, the annular rotary plate 52 is hardly rotated in a smooth manner. In the meantime, the drive shaft 40 is separated from the annular rotary plate 52 by the bearing 51, and therefore, it can be smoothly rotated. Consequently, the load on the drive device 26 can be reduced, and therefore, the drive device 26 can be miniaturized.

Reference characters F, Fr, and Fs in FIG. 3 designate loads acting between the piston 25 and the rotary swash plate 50 at the abutment portion 52a. Reference character F denotes a load acting on the annular rotary plate 52 by the piston 25 at the abutment portion 52a; Fs, a component force of the load F in a thrust direction of the bearing 51; and Fr, a component force of the load F in a radial direction of the bearing 51. As shown in FIG. 3, the angle between the inclination axis 514 and the axis 43 of the drive shaft 40 is about 11 degrees. As for the load at the abutment portion 52a between the piston 29 and the annular rotary plate 50, the component force Fs in the thrust direction of the bearing is greater than the component force Fr in the radial direction of the bearing. That is to say, the bearing 51 mainly supports the component force Fs in the thrust direction at the abutment portion 52a between the piston 25 and the annular rotary plate 52. In summary, the bearing 51 according to the present invention can support the load in the thrust direction, thus effectively supporting the load by the piston 25 so as to enhance load resistance in the piston operational direction of the bearing.

The cylindrical inclination surface 40a is formed at the drive shaft 40 on the inclination axis 514 of the bearing 51, and further, the inner-diameter portion 511a of the first race 511 of the bearing 51 is fitted to the cylindrical inclination surface 40a of the drive shaft 40, so that the first race 511 of the bearing 51 can be fixed to the axis 43 of the drive shaft 40 with the inclination. As a consequence, it is possible to readily form the rotary swash plate 50 provided with the bearing 51 having the inclination axis 514 inclined with respect to the axis 43 of the drive shaft 40.

The rotary swash plate 50 is disposed in the fuel sump chamber 22. The fuel, with which the fuel sump chamber 22 is filled, functions as a lubricant with respect to the bearing 51. However, the fuel pump 20 according to the present embodiment is placed in the atmosphere of high temperature. Moreover, an inside pressure is liable to be decreased by the operation of the piston, and therefore, the vapor is readily generated in the fuel sump chamber 22 inside of the pump. As a consequence, lubrication with respect to the bearing 51 becomes insufficient caused by the vapor generated in the fuel sump chamber 22, thereby leading to a damage on the bearing 51, and therefore, possibly shortening the lifetime of the bearing 51. If the vapor stays at the upper portion of the fuel sump chamber 22, the upper portion of the bearing 51 cannot be soaked in the fuel. In this case, the load may be fluctuated between the upper and lower portions of the bearing, thereby leading to a damage on the bearing 51, and therefore, possibly further shortening the lifetime of the bearing 51. However, the load resistance of the bearing 51 can be improved in the operational direction of the piston 25 in the fuel pump 20 according to the present invention, as described above. Thus, even if the insufficient lubrication with respect to the bearing 51 induces the fluctuation in load between the upper and lower portions of the bearing, it is possible to prevent any damage on the bearing 51 and secure the durability of the bearing 51.

Although the vapor generated inside of the fuel sump chamber 22 is discharged to the fuel tank 12 through the fuel supply port 211, a part thereof is reserved at the upper portion of the fuel sump chamber 22. Moreover, in the case where a large quantity of vapor is generated, the upper portion of the fuel sump chamber 22 is filled with the vapor, and therefore, the vapor is liable to flow into the cylinder 241 arranged above the axis 43 of the drive shaft 40. Consequently, a large quantity of vapor flows into the cylinder 241, thereby raising a possibility of the production of vapor lock or shortage of the fuel to be supplied to the engine 14. In contrast, the number of cylinders 241a arranged above the axis 43 of the drive shaft 40, in which the vapor is liable to flow, is decreased in the rotary swash plate type fuel pump 21 in the present embodiment, thus suppressing the quantity of vapor flowing into the cylinder 241, and as a result, suppressing a decrease in fuel discharge quantity to be supplied to the engine 14.

Since the vapor relief channel 27 is provided, the vapor staying in the fuel sump chamber 22 can be discharged to the fuel tank 12, thus reducing the vapor staying in the fuel sump chamber 22. Consequently, it is possible to prevent any insufficient lubrication with respect to the bearing 51 of the rotary swash plate 50 disposed in the fuel sump chamber 22.

### Second Embodiment

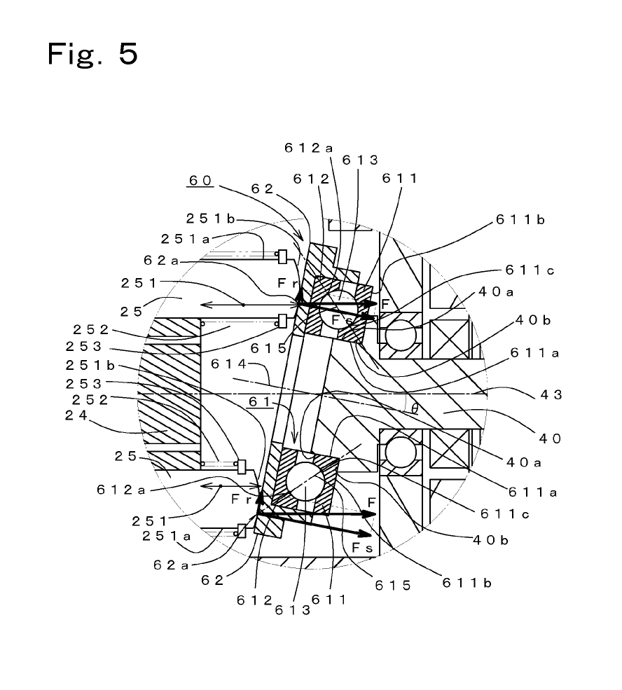

FIG. 5 is an enlarged view showing a bearing in a rotary swash plate type fuel pump 20 according to a second embodiment of the present invention. The second embodiment is different from the first embodiment in a bearing, but the other configuration is identical to that of the first embodiment. Therefore, explanation will be made on only the bearing, but explanation on the other configuration will be omitted. As shown in FIG. 5, a thrust bearing used in a rotary swash plate 60 may be replaced with an angular bearing 61. The use of the angular bearing enables a load in a radial direction to be supported in addition to a thrust load.

The rotary swash plate 60 has an annular rotary plate 62 that slidably abuts against a piston 25 and the angular bearing 61. The angular bearing 61 is provided with a drive side first race 611 that is disposed inside in the radial direction of the bearing 61 and fixed to a drive shaft 40, a driven side second race 612 that is disposed outside in the radial direction of the bearing 61 and fixed to the annular rotary plate 62, and a rolling element 613 interposed between the first race 611 and the second race 612. The angular bearing 61 has an inclination axis 614 inclined with respect to an axis 43 of the drive shaft 40. A straight line 615 connecting a contact point 611c between the first race 611 and the rolling element 613 to a contact point 612a between the second race 612 and the rolling element 613 has a component extending not perpendicularly to the inclination axis 614 but along the inclination axis 614. In this manner, the angular bearing 61 can receive a load in a thrust direction.

Next, explanation will be made on a method for fixing the angular bearing 61 to the drive shaft 40 and the annular rotary plate 62. As shown in FIG. 5, the first race 611 of the angular bearing 61 has an inner-diameter portion 611a on the inclination axis 614 and an annular seat 611b on the drive side perpendicular to the inner-diameter portion 611a. The drive shaft 40 has a cylindrical inclination surface 40a on the inclination axis 614 and a thrust bearing surface 40b perpendicular to the cylindrical inclination surface 40a. When the inner-diameter portion 611a is fitted to the cylindrical inclination surface 40a of the drive shaft 40 whereas the annular seat 611b abuts against the thrust bearing surface 40b of the drive shaft 40, the first race 611 is fixed to the drive shaft 40.

The cylindrical inclination surface 40a and the thrust bearing surface 40b of the drive shaft 40 are formed into component parts integral with the drive shaft 40 by, for example, shaving.

The second race 612 is securely fitted to the annular rotary plate 62. The second race 612 is configured to be relatively operable with respect to the first race 611 via the rolling element 613. Specifically, the drive shaft for fitting the first race and the annular rotary plate 62, to which the second race is fitted, are configured to be rotatable relatively to each other: According to the present embodiment, the bearing 61 is an angular bearing, and therefore, the load resistance with respect to the load in the operational direction of the piston can be increased more than the case of a radial bearing.

### Other Embodiments

The above-described embodiments exemplify that the first race 511 of the bearing 51 is fixed to the cylindrical inclination surface 40a and the thrust bearing surface 40b formed integrally with the drive shaft 40. Alternatively, a drive shaft 40 includes a drive shaft body 41 and a fixed shaft 42 independent of the drive shaft body 41, and then, a cylindrical inclination surface 42a and a thrust bearing surface 42b may be formed at the fixed shaft 42.

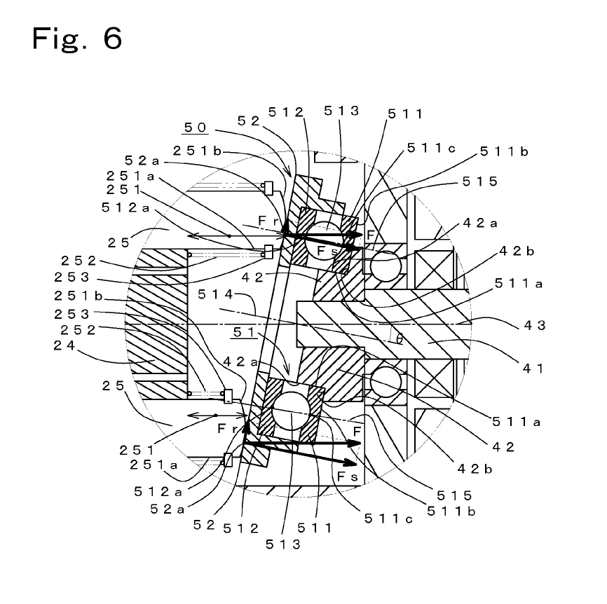

FIG. 6 is an enlarged view showing a drive shaft including a drive shaft body 41 and a fixed shaft 42 independent of the drive shaft body 41. As shown in FIG. 6, the drive shaft body 41 is formed into a cylindrical shape with a step, to which the fixed shaft 42 is fixed. The fixed shaft 42 having a cylindrical inclination surface 42a and a thrust bearing surface 42b is disposed independently of the drive shaft body 41. The fixed shaft 42 is fitted to the drive shaft body 41, thus configuring the drive shaft. In this manner, it is possible to readily fabricate the drive shaft 40.

The fuel suction port 211 in the above-described embodiments is smaller than the upper opening 22a of the fuel sump chamber 22, as shown in FIG. 2. Alternatively, the fuel supply port 211 may be enlarged in a size equal to or greater than the upper opening 22a of the fuel sump chamber 22. In this manner, it is possible to eliminate the above-described region, in which the vapor is liable to stay, so as to prevent insufficient lubrication of the bearing 51 of the rotary swash plate 50 disposed inside of the fuel sump chamber 22.

The annular rotary plate 52 of the rotary swash plate 50 is positioned outside in the radial direction of the second race 512, and further, the piston 25 and the abutment portion 52a of the annular rotary plate 52 are placed outside in the radial direction of the second race 512, thus achieving the bearing having a small diameter. Hence, it is possible to increase a space filled with the fuel around the bearing, so as to suppress fluctuations in pressure due to the reciprocating motion of the piston 25 and suppress the generation of the vapor.

Alternatively, the annular rotary plate 52 of the rotary swash plate 50 may be configured in such a manner as to extend in the direction of the inclination axis 43 so as to partly close a clearance defined between the first race 511 and the second race 512. In this manner, it is possible to prevent dust from intruding around the rolling element 513, and further, to prevent the fuel filled around the rolling element 513 from flowing out, so as to prevent the insufficient lubrication of the bearing 51.

A stopper may be provided for preventing the first race 511 from moving in the direction of the axis 43 of the drive shaft 40 with respect to the drive shaft 40 when the pressing force from the piston 25 is transmitted to the first race 511 via the rolling element 513. It is desirable that stoppers should be provided on both sides of the first race 511 in the direction of the axis 43 of the drive shaft 40. Such a stopper is formed independently of the drive shaft 43. In this manner, it is possible to readily form the drive shaft 43. Since the first race 511 is held between the stoppers, the bearing 51 can be secured in a state inclined with respect to the drive shaft 40.

In the case where the inner-diameter portion She of the first race 511 is greater than the cylindrical inclination surface 40a of the drive shaft 40, it is desirable that a first cylindrical spacer member should be provided for closing a clearance defined between the inner-diameter portion 511a of the first race 511 and the cylindrical inclination surface 40a of the drive shaft 40. The first spacer member extends in the direction of the axis 43 of the drive shaft 40 so as to increase the contact amount with the drive shaft 40. Furthermore, the first spacer member is held between the above-described stoppers, thereby supporting the bearing with the inclination. In this manner, it is possible to suppress a play so as to further enhance durability. Moreover, the first spacer member extends in the radial direction on the side opposite to the rolling element 513 with respect to the first race 511 in abutment against the first race 511, so that the first spacer member can receive the load acting on the first race 511 in the piston operational direction. In the same manner, a second cylindrical spacer member may be provided for reducing a radial clearance defined between the second race 512 and the drive shaft 40. In this manner, it is possible to prevent a play between the second race 512 and the drive shaft 40 since the rotation of the second race till self-alignment.

The drive shaft 40 may penetrate the rotary swash plate 50, and then, is rotatably supported at both ends thereof, and further, may be inhibited from moving in the piston operational direction. In this manner, even if the drive shaft 40 receives the pressing force from the piston, it is possible to suppress swing at the tip of the drive shaft 40.

The above-described embodiments illustrate that the number of cylinders 241 disposed above the axis 43 of the drive shaft 40 is smaller than that of cylinders 241 disposed below, and further, that the vapor relief channel 27 is provided. Alternatively, the number of cylinders 241 disposed above the axis 43 of the drive shaft 40 may be greater than that of cylinders 241 disposed below, and further, no vapor relief channel 27 may be provided.

A thrust ball bearing, a thrust roll bearing, an angular ball bearing, and the like may be adopted as the bearing used according to the present invention.

A configuration in which the fuel pump is actively cooled may be adopted in order to prevent the generation of the vapor. For example, in the case of the water-cooled engine, cooling water may be used to cool the surroundings of the fuel sump chamber. Moreover, fuel having a relatively low temperature may be supplied in order to prevent an increase in temperature at the fuel sump chamber. A structure for spraying fuel toward the bearing may be adopted in order to prevent insufficient lubrication. Specifically, a structure for supplying fuel toward the upper portion of the bearing, at which the fuel probably becomes short, may be adopted. A part of the fuel supplied may be supplied. A communication hole may be formed between the inner and outer surfaces of the drive shaft, and then, the fuel may be injected toward the bearing through the communication hole formed on an inner-diameter side. An agitator such as a fin may be provided at a portion which is rotated together with the drive shaft, thereby agitating the fuel therearound, so as to prevent insufficient lubrication at the upper portion of the bearing.

The above-described embodiments exemplify the fuel pump for the motorcycle. However, the present invention is not limited to the fuel pump for the motorcycle, and therefore, is applicable to a fuel pump for a vehicle and the like provided with an engine.

The present invention may be variously modified and altered without departing from the spirit and scope of the present invention claimed in the scope of claims.

### INDUSTRIAL APPLICABILITY

The durability of the bearing can be secured in the rotary swash plate type fuel pump according to the present invention even in the case where the bearing inside of the rotary shielding plate is insufficiently lubricated since the vapor is generated inside of the fuel pump. Hence, industrial applicability is high.

### DESCRIPTION OF REFERENCE SIGNS

1: Motorcycle
12: Fuel tank
14: Engine
18: Heat shielding plate
20: Rotary swash plate type fuel pump
21: Housing
25: Piston
26: Drive device
27: Vapor relief channel
40: Drive shaft
40a: Cylindrical inclination surface
40b: Thrust bearing surface
41: Drive shaft body
42: Fixed shaft
42a: Cylindrical inclination surface
42b: Thrust bearing surface
43: Axis
50: Rotary swash plate
51: Bearing
511: First race
512: Second race
513: Rolling element
52: Annular rotary plate
70: Fuel filter

1. A fuel pump that is provided outside of a fuel tank, for sucking fuel staying in the fuel tank and supplying the fuel to an engine, the fuel pump comprising:
a drive shaft;
a rotary swash plate fixed to the drive shaft;
a cylinder; and
a piston provided in such a manner as to be biased such that one end of the piston abuts against the rotary swash plate and be movable inside of the cylinder according to the rotation of the rotary swash plate,
wherein the rotary swash plate includes:
an annular rotary plate that abuts against the piston; and
a bearing having a drive side first race fixed to the drive shaft, a driven side second race fixed to the annular rotary plate, and a plurality of rolling elements interposed between the first race and the second race,
the bearing having an inclination axis-inclined with respect to an axis of the drive shaft, and a straight line connecting contact points between the rolling element and the races not being perpendicular to the inclination axis.

2. The fuel pump according to claim 1, wherein the bearing is a thrust bearing or an angular bearing.

3. The fuel pump according to claim 1, wherein the first race has an inner-diameter portion on the inclination axis and an annular seat on the drive side perpendicular to the inner-diameter portion, and
the drive shaft has a cylindrical inclination surface to be fitted to the inner-diameter portion and a thrust bearing surface abutting against the annular seat.

4. The fuel pump according to claim 3, wherein the drive shaft is provided with a drive shaft body and a fixed shaft that is formed independently of the drive shaft body and is fixed to the drive shaft body,
the fixed shaft being provided with the cylindrical inclination surface and the thrust bearing surface.

5. The fuel pump according to claim 1, wherein the fuel pump is mounted on a motorcycle while placing the axis of the drive shaft in a substantially horizontal direction,
the fuel pump further comprising: a fuel suction port communicating with the fuel tank and a fuel sump chamber communicating with the fuel suction port and the cylinder,
wherein the rotary swash plate is disposed inside of the fuel sump chamber, and
the inclination axis extends in a direction crossing a vertical direction.

6. The fuel pump according to claim 5, wherein there are provided a plurality of cylinders,
the number of cylinders disposed below the axis of the drive shaft being greater than that of cylinders disposed above the axis of the drive shaft.

7. The fuel pump according to claim 5, further comprising a vapor relief channel that is formed independently of the fuel suction port and communicates from the fuel sump chamber to the fuel tank.
